(19) United States
(12) Patent Application Publication
(10) Pub. No.: US 2026/0042551 A1
(43) Pub. Date: Feb. 12, 2026

(54) LAUNCH VEHICLE AND METHOD FOR OPERATING A LAUNCH VEHICLE

(71) Applicant: Sascha LARCH, Neusaess (DE)

(72) Inventor: Sascha LARCH, Neusaess (DE)

(21) Appl. No.: 18/232,252

(22) Filed: Aug. 9, 2023

Related U.S. Application Data
(63) Continuation of application No. PCT/EP2022/052612, filed on Feb. 3, 2022.

(30) Foreign Application Priority Data
Feb. 4, 2021 (DE) 102021102637.7

(51) Int. Cl. B64G 1/00; B64G 1/40; B64G 1/42; B64G 1/62; B64U 10/16

(52) U.S. Cl. CPC B64G 1/005; B64G 1/008; B64G 1/409; B64G 1/421; B64G 1/425; B64G 1/428; B64G 1/623; B64U 10/16

(57) ABSTRACT

A launch vehicle with a rocket body having a longitudinal axis which has at least one propulsion stage which can be driven by a reaction propulsion system acting predominantly parallel to the longitudinal axis, wherein the launch vehicle is provided with a plurality of rotors which can be driven by means of a respective rotor drive and whose respective rotor axis is aligned substantially parallel to the longitudinal axis of the rocket body, is characterized in that a separate takeoff stage is provided which is coupled or can be coupled to the rocket body and/or the propulsion stage, which is coupled to or can be coupled to and decoupled from the separate takeoff stage, which has the plurality of outer rotors, in that the outer rotors are arranged in the manner of a multi-copter radially outside the rocket body and surrounding the rocket body.

### RELATED APPLICATIONS

This application is a continuation of International application PCT/EP2022/052612 filed on Feb. 3, 2022 claiming priority from German patent application DE 10 2021 102 637.7 dated Feb. 4, 2021, both of which are incorporated in their entirety by this reference.

### FIELD OF THE INVENTION

The present invention relates to a launch vehicle for space flights. It further relates to methods for operating a launch vehicle.

### BACKGROUND OF THE INVENTION

Rockets intended for flight into space are usually multi-stage in design, with a first propulsion stage provided by means of recoil engines to propel the rocket into the upper reaches of the troposphere to the upper reaches of the stratosphere or even beyond, to an altitude of about 50 to 70 km, where a second propulsion stage is then ignited to transport the rocket into orbit or onto an interplanetary trajectory. The first propulsion stage falls back to earth after the engines have burned out, and the second propulsion stage usually burns up on re-entry into the atmosphere. For several years, successful attempts have been made to allow first propulsion stages equipped with recoil engines to land again in a controlled manner after burnout so that they can be reused. Such reuse of rocket stages should be sought for economic reasons.

CA 2 428 883 A1 shows and describes a single-stage space launch vehicle of essentially square plan, which is provided with rotors in the four corners on its upper side, each having two counter-rotating propellers. In addition, the launch vehicle is provided with a central rocket motor which is used for launch.

DE 4215835 A1 shows and describes a reusable single-stage spacecraft with a circumferential rotor arranged along the equator of the rotationally elliptical device body and a centrally provided and vertically downward directed reaction propulsion system as well as an obliquely downward directed launch reaction propulsion system, which accelerates the spacecraft during launch into an obliquely upward but predominantly horizontally directed trajectory after lift-off effected by means of the circumferential rotor, in order to achieve aerodynamic lift forces on the device body.

US 2020/0262590 A1 shows and describes a vertically launching rocket with a cylindrical rocket stage and a separate launch stage, the launch stage propulsion units of which are arranged around the cylindrical rocket stage and are designed as air-breathing combustion engines.

DE 1020140109 A1 shows and describes a single-stage military missile which is not designed for space flight but for ballistic missile transport and which has a cylindrical fuselage around which four engines equipped with electrically operated propellers are arranged.

### BRIEF SUMMARY OF THE INVENTION

It is the object of the present invention to disclose an improved launch vehicle for flights into space which has a higher reuse ratio.

This object is achieved by a launch vehicle a launch vehicle, comprising: a rocket body including a longitudinal axis, a main propulsion stage drivable by a first reaction propulsion system acting substantially parallel to the longitudinal axis; a plurality of rotors each drivable by a rotor drive and including a respective rotor axis aligned substantially parallel to the longitudinal axis of the rocket body; a separate takeoff stage coupled to or couplable to and decouplable from the rocket body or the propulsion stage, the takeoff stage including a plurality of outer rotors each including a respective outer rotor drive, wherein the outer rotors are arranged in a multi-copter configuration radially outside the rocket body surrounding the rocket body, wherein each respective rotor drive includes at least one electric drive motor, wherein the takeoff stage includes at least one power storage device configured to store electrical energy and to supply electrical energy to the rotor drives, wherein at least a portion of the rotor drives is operable in a generator mode where electrical energy is generatable during an autorotation of the outer rotors, wherein the portion of the rotor drives is configured to feed the electrical energy generated back into the power storage device.

The provision of a launch stage with electrically operated rotor drives according to the invention makes it possible to transport the launch vehicle with its payload initially to a predetermined first altitude level without the use of reaction propulsion systems in the form of rocket motors, wherein the ignition of such reaction propulsion systems of the actual propulsion stage only then takes place in the first altitude level. The electrically driven rotors reduce noise generation during launch and do not produce any engine exhaust gases generated near the ground. The consumption of rocket fuel and the quantity of correspondingly generated exhaust gases are thus reduced, as are the noise generation close to the ground and the exhaust gases generated close to the ground. When the launch stage returns to the earth's surface, the rotor drives of the launch stage can be used to actively approach a selected landing site for the launch stage and perform a controlled landing there. The annular arrangement of the outer rotors in the manner of a multi-copter results in effective, agile and stable controllability of the launch vehicle during lift-off from the launch platform until the first altitude level is reached. The first altitude level is in a range in which the air density of the atmosphere is still sufficiently high that vertical propulsion by means of the rotors is still effective enough for the launch vehicle connected to the launch stage to at least maintain the altitude level reached. When the launch stage decoupled from the launch vehicle falls back to earth, the rotors of the rotor drives are driven by the air flow generated during the fall and cause the electric motor of the associated rotor drive to rotate. The rotor drives, which thus operate as generators, can in this way supply electrical energy to the associated power storage device and charge the latter. This stored energy can in turn be used as drive energy for the rotor drives during the approach phase to the landing site and during landing. The launch stage equipped with the at least one power storage device is energetically autonomous, so that the rotor drives can also be operated in the landing phase after the launch stage has been uncoupled from the propulsion stage or from the rocket body.

Further preferred and advantageous features of the launch vehicle according to the invention are the subject of dependent claims.

Particularly advantageous is a further development in which the propulsion stage forms a main propulsion stage which is coupled or can be coupled to and decoupled from the takeoff stage and which is coupled or can be coupled to and decoupled from the rocket body and/or from an upper stage of the launch vehicle, which upper stage has at least one reaction propulsion system, and in which the main propulsion stage is provided with at least one reaction propulsion system and has a plurality of inner rotors which can each be driven by means of a rotor drive and whose respective rotor axis is aligned essentially parallel to the longitudinal axis of the rocket body, and which are arranged annularly around the longitudinal axis in the manner of a multi-copter. The rotor drives provided in the main propulsion stage can support the rotor drives of the takeoff stage during launch and later, when the main propulsion stage returns, also enable a targeted approach to a landing site for the main propulsion stage and a controlled landing of the main propulsion stage, so that the main propulsion stage can also be reused. Here, too, the annular-shaped, multi-copter-like arrangement of the inner rotors results in effective, agile and stable controllability of the launch vehicle during lift-off from the launch platform until the first altitude level is reached.

According to a further advantageous embodiment of the invention, the upper stage, which is provided with at least one reaction propulsion system, also has a plurality of landing rotors which can each be driven by means of a rotor drive and whose respective rotor axis is aligned essentially parallel to the longitudinal axis of the rocket body, and which are arranged annularly around the longitudinal axis of the rocket body in the manner of a multi-copter in the interior of the upper stage. The provision of these landing rotors also makes it possible to intercept the upper stage in a controlled manner after a controlled re-entry into the earth's atmosphere and a subsequent fall to earth by means of the landing rotors which are then driven, and to fly it to a landing site and land it there. This also makes the upper stage reusable.

It is particularly advantageous if the respective rotor drive has at least one electric motor as the prime mover. Electrically driven rotors of this type reduce noise during takeoff and do not generate any engine exhaust gases near the ground.

It is also advantageous if the main propulsion stage is also provided with at least one power storage device for storing electrical energy and for supplying the inner rotor drives with electrical energy. This means that the main propulsion stage is also energetically autonomous and its rotor drives can also be operated in the landing phase after the launch stage has been uncoupled from the propulsion stage or from the rocket body.

It is also advantageous if the upper stage is provided with at least one power storage device for storing electrical energy and supplying electrical energy to the rotor drives of the inner landing rotors.

A particularly advantageous further development of the takeoff stage and/or the main propulsion stage is characterized in that at least some of the respective rotor drives can be operated in a generator mode in which electrical energy can be generated during autorotation of the associated rotors, and in that the respective rotor drives are designed to return the generated electrical energy to the respectively associated power storage device. When the respective stage uncoupled from the launch vehicle falls back to earth, the rotors of the rotor drives are driven by the air flow generated during the fall and cause the electric motor of the respective associated rotor drive to rotate. The rotor drives, which thus operate as generators, can in this way supply electrical energy to the associated power storage device and charge the latter. This stored energy can in turn be used as drive energy for the rotor drives during the approach phase to the landing site and during landing.

The part of the problem directed to the method of operating a launch vehicle is alternatively solved by the subsequent methods.

In a first method of operating a launch vehicle with a reusable takeoff stage, the launch vehicle is transferred from a launch site to a predetermined first altitude level in a first step by means of the rotor drives of the takeoff stage, where the reaction propulsion system of the propulsion stage is then fired when the first altitude level is reached and the takeoff stage is decoupled from the rocket body or from the propulsion stage. The takeoff stage then descends from the first altitude level and is returned to earth to a landing site.

In a second method of operating a launch vehicle provided with a reusable takeoff stage and a main propulsion stage, the launch vehicle is transferred in a first step by means of the rotor drives of the takeoff stage and the main propulsion stage from a launch site to a predetermined first altitude level, where, upon reaching the first altitude level, the takeoff stage is then decoupled from the rocket body and the main propulsion stage, respectively, and the reaction propulsion system of the main propulsion stage is ignited. The takeoff stage then descends from the first altitude level—as in the first method—and is returned to earth to a landing site. The launch vehicle then continues to fly with the reaction propulsion of the main propulsion stage, whereby the rotor drives of the main propulsion stage no longer contribute to propulsion and are preferably covered for their protection. When the launch vehicle then reaches a second, higher altitude level, the main propulsion stage is decoupled from the rocket body or upper stage and the reaction propulsion of the upper stage is ignited. The main propulsion stage then descends from the second altitude level and is returned to earth to a landing site. If the second altitude level in space is outside the Earth's atmosphere, the main propulsion stage first re-enters the Earth's atmosphere. To protect against the heat generated during re-entry, the main propulsion stage is provided in this case with a heat shield or at least a thermal protection layer, at least in some areas.

In a third method of operating a launch vehicle with a reusable takeoff stage, a main propulsion stage and an upper stage, the launch vehicle is transferred in a first step by means of the rotor drives of the takeoff stage and the main propulsion stage from a launch site to a predetermined first altitude level, whereby upon reaching the first altitude level the reaction propulsion system of the main propulsion stage is ignited and the takeoff stage is decoupled from the rocket body or from the main propulsion stage. The takeoff stage then descends from the first altitude level and is returned to earth. When the launch vehicle reaches a second, higher altitude level, the main propulsion stage is decoupled from the rocket body or upper stage and the reaction propulsion system of the upper stage is ignited. The main propulsion stage then descends to earth from the second altitude level and is returned. After reaching a target orbit, the upper stage, which initially continues to fly, is propelled back to earth by means of at least one reaction propulsion device and is returned to the earth's surface after re-entering the earth's atmosphere.

All three methods according to the invention enable a controlled landing and reusability of the launch stage, the second and third method also enable a controlled landing and reusability of the main propulsion stage and the third method finally enables the reuse of the upper stage.

In all three methods, it is advantageous for the rotors of the takeoff stage to be operated in an autogyro mode during descent within a region of the atmosphere in which the air density is sufficiently high for the rotors to operate, up to a first intercept altitude level, at least a portion of the rotor drives generating electrical energy and feeding it back into the associated power storage device, which is thereby charged. Upon reaching the first intercept altitude level, the rotor drives of the takeoff stage are switched back to a drive mode, whereupon the takeoff stage is operated in a controlled descent and landing mode. The autogyro mode not only stabilizes the uncontrolled descent of the takeoff stage from the first altitude level to the first intercept altitude level, but also provides electrical power that can be used in the subsequent controlled descent, approach and landing.

In the second method, it is advantageous if, in an analogous manner, the rotors of the main propulsion stage are operated in an autogyro mode during descent (within the atmosphere at sufficiently high air density) to a second intercept altitude level, wherein at least a portion of the rotor drives generates electrical energy and feeds it back into the associated power storage device, and when the second intercept altitude level is reached, the rotor drives of the main propulsion stage are switched back to a drive mode, whereupon the main propulsion stage is operated in a controlled descent and landing mode. Again, the autogyro mode not only stabilizes the uncontrolled descent of the main propulsion stage from the second altitude level to the second intercept altitude level, but also supplies electrical energy to the associated power storage device, which can be used again to drive the rotors in the subsequent controlled descent, approach and landing.

The idea of the present invention is thus primarily to provide, in the case of a vertically or essentially vertically launch vehicle, in addition a separate takeoff stage in the manner of a multi-copter with preferably battery-electric rotor or propeller propulsion, which carries the real launch vehicle up to the region of the lower stratosphere, where only then the reaction propulsion systems, for example the rocket motors, are ignited, whereupon the takeoff stage uncoupled from the launch vehicle falls back to earth and is returned in a controlled manner to the launch site or to another landing site by means of its rotor drive systems. During this fall back to earth, the rotor drive systems are preferably operated in autorotation mode (autogyro mode), whereby the rotors or propellers are set in rotation by the air flowing against them during the fall and whereby the rotor shaft drives a generator, preferably the electrical prime mover acting as a generator, and thus generates electrical energy with which the power storage devices are charged for the driven operating state of the rotor drives required during the landing phase.

During the transfer to the stratosphere by means of the takeoff stage, other, preferably battery-electric, rotor drives with associated rotors, which are provided in the first rocket stage, the main propulsion stage, can optionally play a supporting role. Such rotor drives provided in a rocket stage (main propulsion stage or upper stage), which can be constructed like those of the takeoff stage and act in exactly the same way, can decelerate the rocket stage falling back to earth with their respective rotors and thereby preferably generate and store electrical energy, and return it to the launch site or to another landing site in a controlled landing flight with the actively driven rotor drives, whereby the rocket stage can be reused.

Instead of batteries or accumulators, other power storage devices such as supercapacitors or other electrical energy sources such as fuel cells can of course be provided to supply power to the rotor drives.

Preferred embodiments of the invention with additional design details and further advantages are described and explained in more detail below with reference to the accompanying drawings.

### BRIEF DESCRIPTION OF THE DRAWINGS

The invention is now described with based on advantageous embodiments with reference to drawing figures, wherein:

FIG. 1 illustrates a vertical section through a first embodiment of a launch vehicle according to the invention;

FIG. 2 illustrates a horizontal section through a main propulsion stage of the first embodiment according to the invention along line II-II in FIG. 1;

FIG. 3 illustrates a top view of a takeoff stage designed according to the invention;

FIG. 4 illustrates a vertical section through a second embodiment of a launch vehicle according to the invention;

FIG. 5 illustrates a horizontal section through a main propulsion stage of the second embodiment according to the invention along the line V-V in FIG. 4 and FIG. 6 illustrates a horizontal section through an upper stage of the second embodiment according to the invention along line VI-VI in FIG. 4.

### DETAILED DESCRIPTION OF THE INVENTION

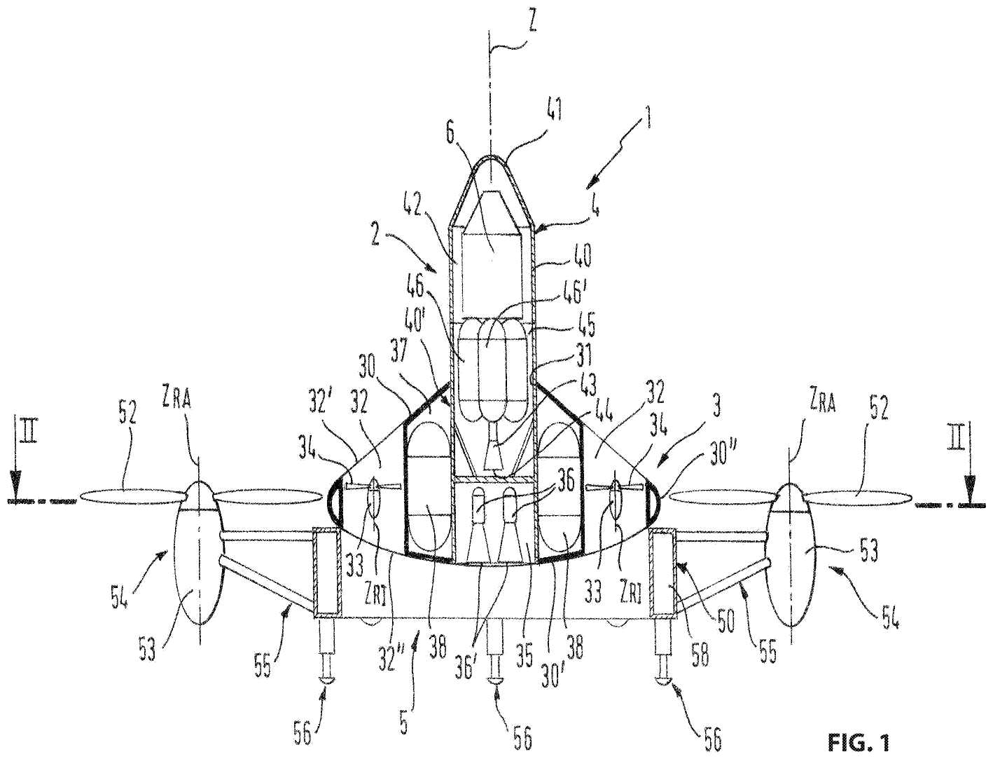

FIG. 1 shows a vertical section through a first embodiment of a launch vehicle 1 according to the invention. The launch vehicle 1 comprises a rocket body 2, which has a main propulsion stage 3 and an upper stage 4 and which is connected to a takeoff stage 5 in a decouplable manner in the region of its main propulsion stage 3.

The upper stage 4 is substantially formed by a cylindrical housing shell 40, which is provided with a conical upper tip 41 that can be tilted down. A payload compartment 42 for receiving a payload 6 is formed in the upper portion of the upper stage 4, which is accessible by folding open the conical tip 41 so that the payload 6 can be deposited in space out of the payload compartment 42.

In the lower region of the upper stage 4, i.e., on the lower side facing away from the conical tip 41, a recoil drive or hereinafter also called reaction propulsion system 43 is provided, the outlet nozzle 44 of which is directed downward and which is arranged coaxially to the vertical longitudinal axis Z of the launch vehicle 1. A supply room 45 is provided between the reaction propulsion system 43 and the payload compartment 42, in which supply room a plurality of propellant tanks 46, 46′ are arranged, which contain the propellants for the operation of the reaction propulsion system 43 and which are connected to the reaction propulsion system 43 via corresponding propellant lines (not shown).

The lower area 40′ of the cylindrical housing shell 40 of the upper stage 4 facing away from the conical tip 41 engages in an adapted cylindrical receiving opening 31 in the upper side of the housing shell 30 of the main propulsion stage 3 and is detachably inserted there. The upper stage 4 is connected to the main propulsion stage 3 in such a way that it can be decoupled.

The housing shell 30 of the main propulsion stage 3 is of spherical sector-like shape with a convex lower wall 30′ facing away from the upper stage 4. In this case, the reusable first rocket stage of the launch vehicle 1 formed by the main propulsion stage 3 has the shape of a flat truncated cone with a convex base, similar to an Apollo capsule. The outer diameter of the main propulsion stage 3 is significantly larger than the outer diameter of the cylindrical upper stage 4. In the example shown, the outer diameter of the main propulsion stage 3 is about four times the outer diameter of the upper stage 4.

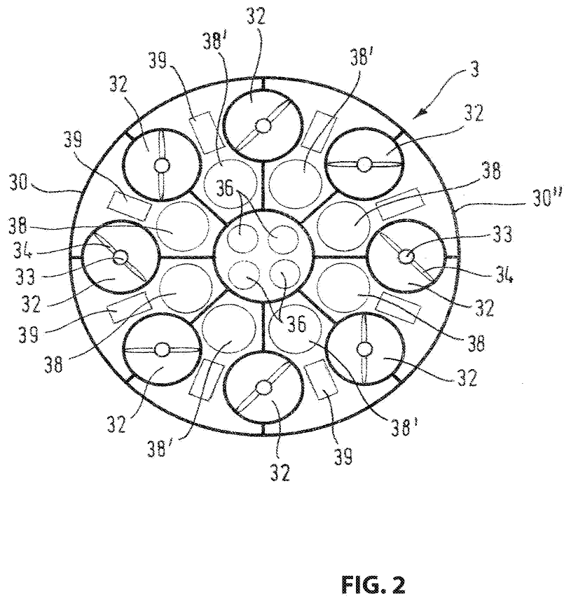

In its radially outer region, close to the largest circumferential edge 30″ of the housing shell 30 of the main propulsion stage 3, vertical air ducts 32 running parallel to the longitudinal axis Z of the launch vehicle 1 are provided distributed over the circumference of the main propulsion stage 3. Preferably, eight vertical air ducts 32 are provided (FIG. 2). A propeller-like inner rotor 34 drivable by an electric rotor drive 33 is arranged in each of the air ducts 32, the respective inner rotor axis Z_{RI} of which runs parallel to the longitudinal axis Z of the launch vehicle 1. The upper openings 32′ and the lower openings 32″ of the air ducts 32 can be closed in the region of the housing shell 30 by means of (not shown) protective flaps.

A central engine compartment 35 is provided in the main propulsion stage 3, centrally below the receiving opening 31 for the upper stage 4, with a plurality of reaction propulsion systems 36 whose respective outlet nozzles 36′ open downward away from the payload compartment 42. The engine compartment 35, which is open downward during operation of the reaction propulsion systems 36, can be closed by protective flaps (not shown). In particular, during a drop of the reusable main propulsion stage 3 back to earth, these protective flaps close the engine compartment 35.

Fuel tanks 38, 38′ for supplying the reaction propulsion systems 36 are arranged distributed around the circumference in an annular interior region 37 between the vertical air ducts 32 and the central engine compartment 35. Radially outside this annular interior region 37, electric power storage devices 39 for supplying power to the electric rotor drives 33 are provided in the circumferential direction between the air ducts 32. Alternatively, the rotor drives 33 can also be supplied with electrical energy from power storage devices provided in the takeoff stage 5.

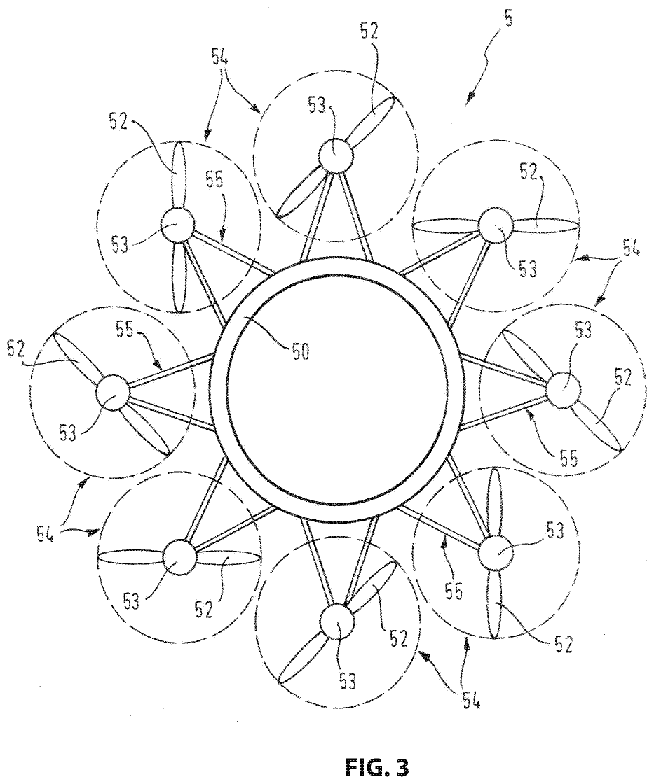

The convex lower wall 30′ of the main propulsion stage 3 rests on an annular structural element 50 of the isolated takeoff stage 5 shown in FIG. 3, where it is connected to the takeoff stage 5 in such a way that it can be decoupled. This decouplable connection can be formed, for example, by means of (not shown) retaining clips. These retaining clips can also be used to transmit electrical energy from the takeoff stage 5 to the main propulsion stage 3.

The takeoff stage 5 has a plurality of propeller-like outer rotors 52 arranged around the ring structure element 50, each of which is drivable by an electric rotor drive 53 for rotation about a respective outer rotor axis Z_{RA}, which is parallel to the longitudinal axis Z of the launch vehicle 1. The respective electric rotor drive 53 and the outer rotor 52 associated therewith together form a respective rotor drive nacelle 54. Each rotor drive nacelle 54 is mechanically connected to the ring structure element 50 via an associated support structure 55.

As can be seen in FIG. 3, in the example shown there, eight rotor drive nacelles 54 are evenly arranged in a ring around the ring structure element 50 at a distance of 45° from each other, so that the takeoff stage 5 is multi-copter-like in the manner of an octocopter. A plurality of landing legs 56 are provided on the ring structural element 50 on the underside facing away from the rocket body 2. Inside the ring structure element 50, electrical power storage devices 58 are provided, which are electrically conductively connectable or connected to the rotor drives 53 via (not shown) electrical lines.

In an alternative embodiment, the upper stage 4 can also be completely enclosed by the housing shell 30 of the main propulsion stage 3, which then has the cylindrical upper housing shell with the hinged tip 41. In this embodiment, the upper stage can be exposed through the hinged tip 41 together with the payload 6 provided in or on the upper stage 4.

The embodiment of launch vehicle 1 shown in FIGS. 1 to 3 forms a partially reusable launch vehicle system for small and medium payloads to be transported, for example, into a sun-synchronous orbit.

The flight sequence of the first embodiment of launch vehicle 1 shown in FIGS. 1 to 3 is as follows:

During launch, the rotors of takeoff stage 5 and main propulsion stage 3 are initially operated together, with the rotors 52 of main propulsion stage 3 being fed from the power storage devices 58 of takeoff stage 5 or from on-board power storage devices 39. The launch stage with the mounted launch vehicle 1 ascends vertically upward at a speed of, for example, 50 m/s (180 km/h) to the lower region of the stratosphere, for example to an altitude of about 15 km. At this altitude, the rocket engine, i.e., the reaction propulsion system 43, of the main propulsion stage 3 is ignited and the retaining clamps between the takeoff stage 5 and the main propulsion stage 3 are released. At the same time, the power supply to the rotors of the main propulsion stage is switched to the internal power storage devices 39. The power storage devices 58 of the takeoff stage 5 are now empty and the rotor drives 53 of the takeoff stage 5 are switched off, whereupon the takeoff stage 5 enters a free fall. During this dive, the outer rotors 52 are set in rotation by the incoming air (autorotation), which on the one hand decelerates the fall of the launch stage and on the other hand partially recharges the power storage devices 58 of takeoff stage 5 by operating the rotor drives 53 formed by electric motors as generators. At a suitable altitude, the rotor drives 53 are switched on again and the fall back is intercepted. The takeoff stage 5 then lands again in a controlled manner at the launch site or at another predetermined landing site.

In the meantime, the main propulsion stage 3 continues its flight, with the rotors 34 and the rotor drives 33 of the main propulsion stage 3 still running as long as they generate thrust. After the reaction propulsion systems 36 of the main propulsion stage 3 have burned out, the tip 41 is opened and the upper stage 4 with the payload 6 suspended continues its flight. The upper stage 4 of this embodiment is not reusable.

The return of the main propulsion stage 3, which is also reusable, can be accomplished in two ways. Either the reaction propulsion systems 36 of the main propulsion stage 3 are fired again, against the direction of flight, to perform a “boost-back” maneuver and the main propulsion stage 3 then falls back to the launch site on a parabolic trajectory, or the main propulsion stage 3 falls back to earth without “boost-back” but then lands away from the original launch site, e.g., on a ship. In both cases, after the last engine firing of the reaction propulsion systems 36, the protective flaps of the engine compartment 35 are closed and the main propulsion stage 3 returns to the ground in free fall. As with the takeoff stage 5, the fall is decelerated by autorotation of the inner rotors 34 and the rotor drives 33, and the batteries of the main propulsion stage 3 are recharged. The fall is intercepted by switching on the rotor drives 33, but the landing takes place on a prepared air cushion, in contrast to the takeoff stage. After the flight and the return of the takeoff stage 5 and the main propulsion stage 3, these are checked, repaired if necessary and prepared for the next flight.

The launch vehicle 1 according to the invention can also be used as a sounding rocket by installing an appropriate experiment package instead of the upper stage.

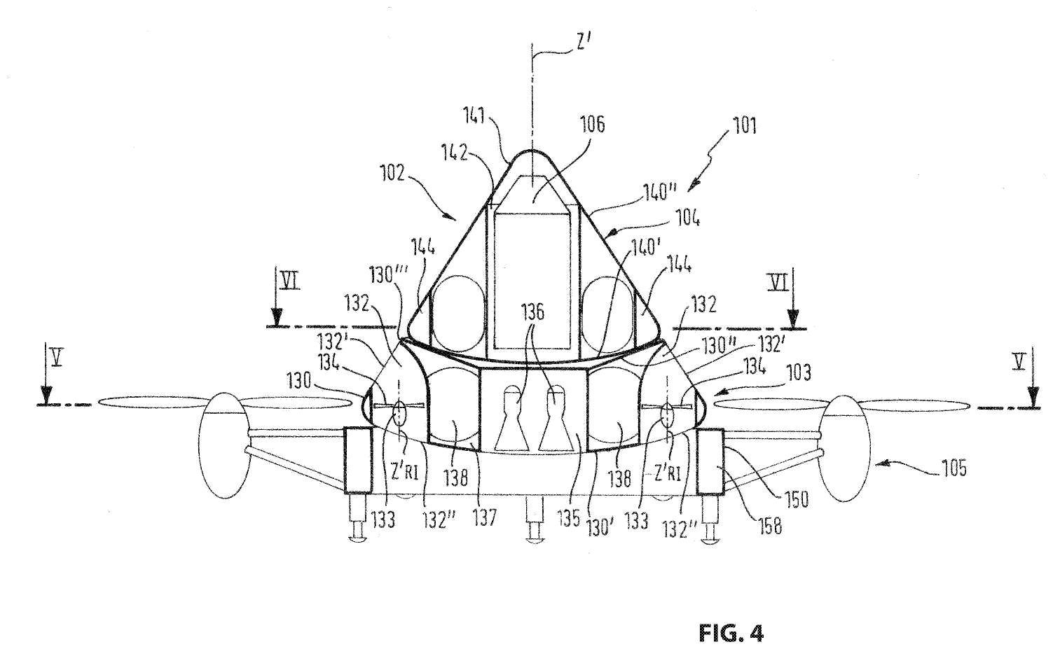

FIG. 4 shows a second embodiment of a launch vehicle 101 according to the invention with a main propulsion stage 103 and an upper stage 104 carrying a payload 106. The unit forming the rocket body 102, consisting of main propulsion stage 103 and upper stage 104, has a spherical sector-like shape and forms the shape of a flat truncated cone with a convex base, similar to an Apollo capsule. As in the first embodiment, this launch vehicle 101 is also provided with a takeoff stage 105 which is designed in the same way as the takeoff stage 5 of the first embodiment shown in FIG. 3; the same explanations therefore apply to the takeoff stage 105 as have been described in connection with FIG. 3 for the takeoff stage 5.

The main propulsion stage 103 is also constructed analogously to the main propulsion stage 3 of the first embodiment, but the outer shape of the main propulsion stage 103 differs from the first embodiment, since the housing shell 130 of the main propulsion stage 103 describes a hollow sphere sector with a convex outwardly curved lower wall 130′ and a concave inwardly curved upper wall 130″.

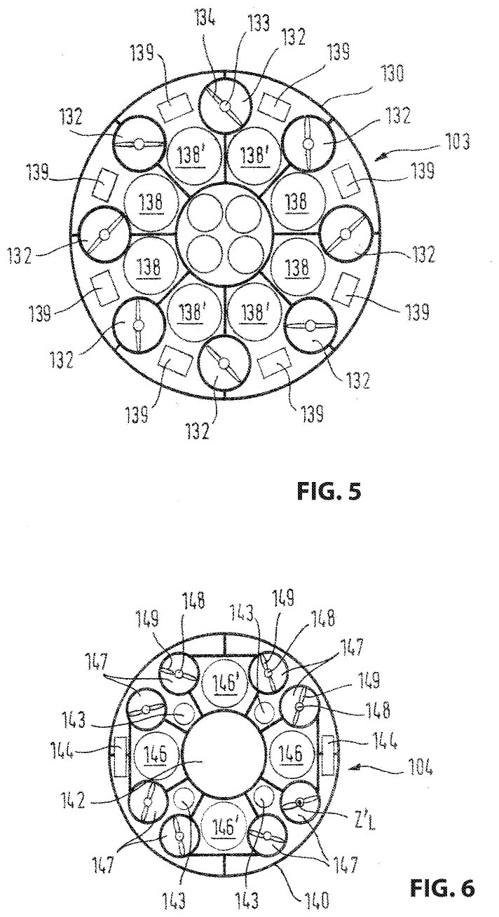

Like in the first embodiment, the main propulsion stage 103 is provided with air ducts 132 distributed over the circumference of the main propulsion stage 103 in the lower region vertically and axis-parallel to the vertical longitudinal axis Z′ of the launch vehicle 101. Preferably, eight vertical air ducts 132 are provided (FIG. 5). Also in this second embodiment, the respective air duct 132 extends upwardly from a respective lower opening in the convexly outwardly curved lower wall 130′ to an orifice in the cone-shell-like side surface 130″ of the housing shell 130. Due to the shown two-stage design of this exemplary second embodiment, the upper portion of the respective air duct 132 is curved obliquely outwardly. The central engine compartment 135 with the recoil rives or reaction propulsion systems 136 and the annular interior region 137 with the fuel tanks 138, 138′ contained therein correspond in their design to the first embodiment, as can be seen in FIG. 5.

In each of the air ducts 132, a propeller-like inner rotor 134 drivable by an electric rotor drive 133 is also arranged here, the respective inner rotor axis Z′_{RI} of which extends parallel to the longitudinal axis Z′ of the launch vehicle 101. The upper openings 132′ and the lower openings 132″ of the air ducts 132 can be closable in the region of the side surfaces 130′″ and the convex lower wall 130′ by means of (not shown) protective flaps.

Also in the second embodiment, electrical power storage devices 139 are provided radially outside this annular interior region 137 to supply power to the electrical rotor drives 133 in the circumferential direction between the air ducts 132. Alternatively, the rotor drives 133 may be supplied with electrical power from electrical power storage means 158 provided in the annular structural element 150 of the takeoff stage 105.

As in the first embodiment, the main propulsion stage 103 rests with its convex lower wall 130′ on an annular structural element 150 of the takeoff stage 105 and is connected there to the takeoff stage 105 in such a way that it can be decoupled. This decouplable connection can be realized, for example, by means of (not shown) retaining clips. These retaining clips can also be used to transmit electrical energy from the takeoff stage 105 to the main propulsion stage 103.

The upper stage 104 has a spherical sector-like shape similar to an Apollo capsule and forms the shape of a flat truncated cone with a convex base formed by a convex lower wall 140′ whose curvature corresponds to the curvature of the concave inwardly curved upper wall 130″ of the main propulsion stage 103. The convex lower wall 140′ of the upper stage 104 rests on the concave inwardly curved upper wall 130″ of the main propulsion stage 103. Uncouplable coupling means hold the upper stage 104 to the main propulsion stage. Preferably, the convex lower wall 140′ of the upper stage 104 is externally provided with a heat shield (not shown) which protects the upper stage 104 during re-entry into the earth's atmosphere.

As with the first embodiment, this upper stage 104 is also provided with a hinged conical upper tip 141. A payload compartment 142 is formed in the upper portion of the upper stage 104 for receiving the payload 106, which is accessible by folding open the conical tip 141 so that the payload 106 can be deposited in space out of the payload compartment 142. The lateral wall 140″ of the housing shell 140 of the upper stage 104 has a cone shell-like side surface that merges with the cone shell-like side surface of the main propulsion stage 103.

As can be seen in the horizontal sectional view of FIG. 6, the upper stage 104 is also equipped in its radially outer region with substantially vertically extending air ducts 147, in each of which a landing rotor 149, which can be driven by an electric rotor drive 148, is arranged and can be rotated about a respective rotor axis Z′_{L} which extends parallel to the longitudinal axis Z′. The upper openings and the lower openings of the air ducts 147 are closable in the region of the lateral wall 140″ of the housing shell 140 and the convex lower wall 140′ of the upper stage 104 by means of (not shown) protective flaps. The electric rotor drives 148 are electrically conductively connected to electric power storage devices 144 in the upper stage 104.

Around the payload compartment 142, as can be seen in FIG. 6, coaxial to the vertical longitudinal axis Z of the launch vehicle 1, four reaction propulsion systems 143 are provided, the respective outlet nozzle of which is directed downward. The outlet openings (not shown) in the convex lower wall 140′ of the upper stage 104 surrounding the respective outlet nozzle can be closed by protective flaps (not shown).

Between the recoil actuators 143 and the paired air ducts 147 are fuel tanks 146, 146′ which contain the propellants for operating the reaction propulsion systems 143 and which are connected to the reaction propulsion systems 143 via corresponding fuel lines (not shown).

The embodiment of launch vehicle 101 shown in FIGS. 4 to 6 forms a fully reusable launch vehicle system for small and medium payloads to be transported, for example, to a sun-synchronous orbit.

The flight sequence of the second embodiment of the launch vehicle 101 shown in FIGS. 4 to 6 is as follows:

The sequence of flight of the takeoff stage 105 and the main propulsion stage 103 is the same as that described in connection with the first embodiment, with the protective flaps for the air ducts 147 closed.

The upper stage 104 with the payload 106 reaches orbital velocity. After the payload 106 is released into orbit, the upper stage 104 is decelerated by re-igniting its reaction propulsion systems 143 to the point where it re-enters the atmosphere in a ballistic trajectory. Prior to reentry, the protective flaps for the reaction propulsion systems 143 are closed. The protective flaps for the air ducts 147 remain closed. The landing of the upper stage 104 is carried out, as in the case of the main propulsion stage 103, by opening the protective flaps for the air ducts and switching on the rotor drives 148 and then intercepting the dive by means of the rotor drives 148 as has been described analogously in connection with the main propulsion stage. The controlled landing also takes place here on a prepared air cushion.

The launch vehicle 101 of the second embodiment may also be used for returnable payloads that are permanently installed in the upper stage 104 and return to Earth along with the upper stage 104 at the end of the mission.

Reference numerals in the claims, the description and the drawings serve only for a better understanding of the invention and do not limit the scope of protection.

### REFERENCE NUMERALS AND DESIGNATIONS

1 launch vehicle
2 rocket body
3 main propulsion stage
4 upper stage
5 takeoff stage
30 housing shell of the main propulsion stage 3
30′ convex lower wall
30″ peripheral edge of housing shell 30
31 cylindrical receiving opening
32 air ducts
32′ upper openings
32″ lower openings
33 electric rotor drive
34 inner rotor
35 central engine room
36 reaction propulsion system
37 annular interior area
38 fuel tank
38′ fuel tank
39 electric power storage device
40 cylindrical housing shell
40′ lower area of cylindrical housing shell 40
41 conical tip
42 payload compartment
43 reaction propulsion system
44 outlet nozzle
45 supply room
46 fuel tank
46′ fuel tank
50 ring structure element
52 outer rotor
53 electric rotor drive
54 rotor drive nacelle
55 support structure
56 landing leg
58 power storage devices
101 launch vehicle
102 rocket body
103 main propulsion stage
104 upper stage
105 takeoff stage
106 payload
130′ lower wall
130″ top wall
130′″ side surface
132 air duct
132′ upper opening of the air duct 132
132″ lower opening of the air duct 132
133 electric rotor drive
134 inner rotor
135 central engine room
136 reaction propulsion system
137 annular interior area
138 fuel tank
138′ fuel tank
139 electric power storage device
140 housing shell of upper stage 104
140′ lower wall of upper stage 104
140″ lateral wall of housing shell 140
141 conical tip
142 payload compartment
143 reaction propulsion system
146 fuel tank
146′ fuel tank
147 air duct
148 electric rotor drive
149 landing rotor
150 ring structure element
158 electric power storage devices
Z longitudinal axis
Z′ vertical longitudinal axis
Z′_{L} rotor axis
Z_{RI} inner rotor axis
Z′_{RI} inner rotor axis
Z_{RA} outer rotor axis

What is claimed is:

1. A launch vehicle, comprising:
a rocket body including a longitudinal axis, a propulsion stage drivable by a first reaction propulsion system acting substantially parallel to the longitudinal axis;
a plurality of rotors each drivable by a rotor drive and including a respective rotor axis aligned substantially parallel to the longitudinal axis of the rocket body;
a separate takeoff stage coupled to or couplable to and decouplable from the rocket body or the propulsion stage, the takeoff stage including a plurality of outer rotors each including a respective outer rotor drive,
wherein the outer rotors are arranged in a multi-copter configuration radially outside the rocket body surrounding the rocket body,
wherein each respective outer rotor drive includes at least one electric drive motor,
wherein the takeoff stage includes a power storage device configured to store electrical energy and to supply the electrical energy to the outer rotor drives,
wherein a portion of the outer rotor drives is operable in a generator mode where electrical energy is generatable during an autorotation of the outer rotors,
wherein the portion of the outer rotor drives is configured to feed the electrical energy generated back into the power storage device.

2. The launch vehicle according to claim 1,
wherein the propulsion stage forms a main propulsion stage which is coupled to or couplable to and decouplable from the takeoff stage and which is coupled to or couplable to and decouplable from the rocket body or from an upper stage of the launch vehicle,
wherein the upper stage includes a second reaction propulsion system, and
wherein the main propulsion stage includes the first reaction propulsion system and a plurality of inner rotors each drivable by an inner rotor drive and whose respective rotor axis is aligned essentially parallel to the longitudinal axis of the rocket body, and
wherein the inner rotors are arranged in an annular pattern about the longitudinal axis in a multi-copter configuration.

3. The launch vehicle according to claim 2,
wherein the upper stage includes a third reaction propulsion system and a plurality of internal landing rotors each drivable by a landing rotor drive and whose respective rotor axis is aligned essentially parallel to the longitudinal axis of the rocket body, and which are arranged in an annular pattern around the longitudinal axis in a multi-copter configuration in an interior of the upper stage.

4. The launch vehicle according to claim 2, wherein each inner rotor drive and landing rotor drive includes a respective electric motor as a prime mover.

5. The launch vehicle according to claim 2, wherein the main propulsion stage includes a power storage device configured to store electrical energy and supply the inner rotor drives with the electrical energy.

6. The launch vehicle according to claim 3, wherein the upper stage includes a power storage device configured to store electrical energy and supply the electrical energy to the landing rotor drives of the inner landing rotors.

7. The launch vehicle according to claim 5,
wherein a portion of the inner rotor drives and the landing rotor drives is operable in a generator mode where electrical energy is generatable during an autorotation of the inner rotors and the landing rotors,
wherein the inner rotor drives and the landing rotor drives are configured to return electrical energy generated to a respectively associated power storage device.

8. A method for operating the launch vehicle according to claim 1 including the reusable takeoff stage, the method comprising:
transferring the launch vehicle from a launch site to a predetermined first altitude level in a first step by using the outer rotor drives of the takeoff stage;
upon reaching the first altitude level igniting the first reaction propulsion system of the propulsion stage and decoupling the takeoff stage from the rocket body or from the propulsion stage; and
descending the takeoff stage from the first altitude level and returning the takeoff stage to a takeoff site.

9. A method for operating the launch vehicle according to claim 2 including the reusable takeoff stage and the main propulsion stage, the method comprising:
transferring the launch vehicle from a launch site to a predetermined first altitude level in a first step using outer the rotor drives and the inner rotor drives of the takeoff stage and the main propulsion stage;
igniting the first reaction propulsion system of the main propulsion stage and decoupling the takeoff stage from the rocket body and from the main propulsion stage respectively when reaching the first altitude level;
descending the takeoff stage from the first altitude level and returning the takeoff stage to a launch site;
igniting the second reaction propulsion system of the upper stage and decoupling the main propulsion stage from the upper stage upon reaching a second altitude level; and
descending the main propulsion stage from the second altitude level and returning the main propulsion stage to the launch site.

10. A method for operating the launch vehicle according to claim 3 including the reusable takeoff stage, the main propulsion stage and the upper stage, the method comprising:
transferring the launch vehicle from a launch site to a predetermined first altitude level in a first step using the inner rotor drives of the takeoff stage and the main propulsion stage;
igniting the reaction propulsion system of the main propulsion stage and decoupling the takeoff stage from the rocket body and from the main propulsion stage respectively;
descending the takeoff stage from the first altitude level upon reaching the first altitude level and returning the takeoff stage to the launch site;
igniting the reaction propulsion system of the upper stage and decoupling the main propulsion stage from the upper stage upon reaching a second altitude level, and descending the main propulsion stage from the second altitude level and returning the main propulsion stage to the launch site; and
propelling the upper stage back to earth using a reaction propulsion device after reaching a target orbit and returning the upper stage back an earth surface after re-entering the earth's atmosphere.

11. The method according to claim 8, further comprising:
operating the outer rotors of the takeoff stage in an autogiro mode when descending to a first intercept altitude level, so that a portion of the outer rotor drives generates electrical energy and feeding the electrical energy back into the associated power storage device; and
switching the rotor drives of the takeoff stage back to a drive mode upon reaching the first intercept altitude level and operating the takeoff stage in a controlled descent and landing mode.

12. The method according to claim 9, further comprising:
operating the inner rotors of the main propulsion stage in an autogiro mode when descending to a second intercept height level with a portion of the inner rotor drives generating electrical energy and feeding it back into the associated power storage device, and
switching the inner rotor drives of the main propulsion stage back to a drive mode upon reaching the second intercept altitude level and operating the main propulsion stage in a controlled descent and landing mode.

13. The method according to claim 10, further comprising:
operating the landing rotors of the upper stage in an autogiro mode during descent within the earth's atmosphere to a third intercept altitude level with at least a portion of the landing rotor drives generating and returning electrical energy to the associated power storage device;
switching the landing rotor drives of the upper stage to a drive mode upon reaching the third intercept altitude level; and thereafter
operating the upper stage in a controlled descent and landing mode.
